(19) United States
(12) Patent Application Publication
(10) Pub. No.: US 2003/0002479 A1
(43) Pub. Date: Jan. 2, 2003

(54) Virtual call center

(75) Inventors: Pnina Vortman, Haifa (IL); Uzi Shvadron, D.N. Misgav (IL); Roni Klimer, Yokneam Illit (IL); Ran Cohen, Haifa (IL); Edward Dahmus, Boca Raton, FL (US); Baiju Mandalia, Boca Raton, FL (US)

Correspondence Address: BROWDY AND NEIMARK, P.L.L.C., 624 NINTH STREET, NW, SUITE 300, WASHINGTON, DC, 20001-5303, US

(73) Assignee: INTERNATIONAL BUSINESS MACHINES CORPORATION, Armonk, NY

(21) Appl. No.: 09/896,107

(22) Filed: Jul. 2, 2001

(51) Int. Cl. H04L 12/66

(52) U.S. Cl. 370/352; 370/392

(57) ABSTRACT

An adapter device includes a telephone port, for coupling to a line connector of a telephone, a computer port, for coupling to a communication port of a computer terminal, and a line port, for coupling to a telephone line, which is linked to a telephone network. The device operates in a plurality of operational modes, including at least a first operational mode, in which the circuitry couples the telephone via the line port to the telephone line so as to enable a telephone call to be conducted over the telephone network using the telephone, while the circuitry conveys data regarding the call to the terminal via the computer port, and a second operational mode, in which the circuitry couples the telephone via the computer port to the computer terminal, so that the telephone operates as an audio input/output device of the terminal.

### FIELD OF THE INVENTION

The present invention relates generally to enterprise call centers, and specifically to distributing call center functions over wide areas, beyond the confines of a physical call center facility.

### BACKGROUND OF THE INVENTION

For many businesses, call centers play increasingly important roles in providing superior customer service in a cost-effective manner. Call centers enable businesses to offer their customers products, services and customer support 24 hours a day, seven days a week. Sophisticated switching equipment and software for call centers provide Automatic Call Distribution (ACD) capabilities, enabling customer calls to be routed efficiently to agents in the call center who have the appropriate skills to handle the customers' specific requirements. The software keeps records of calls in order to track customer needs and preferences, manage the agents' states and activities, and maintain statistics on agents' performance. The software also balances the load of incoming calls from customers among the available agents, using data provided by the switching equipment, in order to maximize the efficiency of use of call center resources and minimize customer waiting time.

FIG. 1 schematically illustrates a typical call center 20, as is known in the art. The call center is populated by agents located within the call center facility, which is typically a large room. Each agent is equipped with a telephone extension 28 and a PC terminal 34. The telephone extension is linked to communicate with a Public Switched Telephone Network (PSTN) 24 through a Private Branch Exchange (PBX) switch 26. This switch may also be equipped to perform some or all of the load balancing and automatic call distribution (ACD) functions described above. Examples of call center switches with ACD capability include the Definity® Enterprise Communications Server (ECS), produced by Lucent Technologies, and similar switches made by Meridien and by SumaFour. Alternatively, switch 26 may comprise a standard PBX to which ACD capabilities are added by an appropriate Computer Telephony Integration (CTI) server 30, such as the CallPath™ Enterprise or Genesis system produced by IBM Corporation.

Typically, incoming calls to call center 20 from a customer telephone 22 are initially handled by an Interactive Voice Response (IVR) function that is integrated with switch 26. This function generates a Vector Directory Number (VDN) for each call, indicating the type of service that the customer requires. In response to the incoming call, switch 26 generates an event message to server 30, which then assembles the information that will be needed by the agent to whom the call is routed. Server 30 is responsible for coordination between the voice calls routed to agent telephone extension 28 and the information appearing on terminal 34 of the agent handling the call. Terminal 34 runs a suitable call handling program, which is typically integrated with other software functions running on the agent PC. Server 30, terminals 34 and the various other elements of center 20 are linked via a local area network (LAN) 32 to back office servers 36, which perform functions such as database management, order processing, and so forth.

Increasingly, business Web sites offer packet telephony links to their call centers, typically in the form of Voice over Internet Protocol (VoIP) communications. For this purpose, for example, Lucent Technologies offers an Internet Call Center, which is described in a White Paper (Lucent Technologies, Dec. 15, 1997), which is incorporated herein by reference. The Internet Call Center is built around an Internet Telephony Gateway (ITG) and a Java CTI server, integrated with a Definity ECS, which serves as the call center switching equipment. Communications between the ITG, CTI and agent terminals are generally carried out using the Java Telephony Application Program Interface (JTAPI), as described, for example, in the JTAPI Programmer's Reference and the JTAPI Client Programmer's Guide (Lucent Technologies, October, 1997), which are incorporated herein by reference. A Web site using the Internet Call Center can offer the customer the options of placing a VoIP call to the call center over the Internet, using a Java applet that the ITG downloads to the customer's computer, or of requesting a callback from the center to a telephone number that the customer specifies. The customer typically invokes these options by selecting appropriate on-screen controls on certain pages of the Web site.

Lucent also offers the “Avaya” line of products, which integrate telephony services and enterprise software functions on the employee's computer. These products are described at www.lucent.com/enterprise/solutions/eclips/. For example, the Avaya IP600 IP Communication Server provides telephone service to IP telephones and computer “softphones” over a LAN in a corporate office or over a Wide Area Network (WAN) linking different company branches. The Avaya IP Softphone provides voice, fax, data, e-mail and other communication features on a PC or laptop computer for employees who work outside the main office. The Avaya CentreVu® Agent (described at wwwdb.lucent.com/bcs/solutions/) consolidates the functions of an agent telephone, CTI software, headset adapters and agent announcements into the call center agent's PC. Although these products may enable the agent to perform his or her job more efficiently, they still rely on the central PBX/ACD switch in the call center to handle and switch all customer calls.

### SUMMARY OF THE INVENTION

Preferred embodiments of the present invention provide a virtual call center, in which agents are freed of the need to be connected to a central switch for telephone service. The agent equipment is configured, however, so as to enable the agent to work in the virtual call center—whether in the central office or at a remote location—using the same methods and habits. In particular, the agent continues to use his or her telephone for voice communications, preferably including both analog communications over the PSTN and IP telephony, while conducting data interactions on the PC.

In some preferred embodiments of the present invention, the agent's telephone is connected by a novel phone adapter device to the agent's PC, as well as to the PSTN line. The adapter has the ability to control and monitor telephone functions, such as ring, dial, pick-up and hang-up, and voice transfer. The PC is equipped with special drivers and CTI software for interfacing with the telephone via the adapter, as well as for interacting with the enterprise call center and providing a CTI interface to the agent. A routing server in the call center performs the call distribution and tracking functions normally carried out by the ACD switch or CTI server, by communicating with the agent PCs over packet network connections, both inside and outside the call center. There is no longer any need for a PBX to switch voice calls among the agents' telephone extensions, and the CTI function of coordinating between telephone and PC operations is carried out by the agent PC itself, via the phone adapter.

The phone adapter enables the agent's telephone to be used both as a telephone line interface for analog calls over the PSTN line and as an audio interface device for VoIP calls through the agent's PC. Thus, in one mode of operation, when a customer calls into the call center over a PSTN line and the routing server determines that the call is to be handled by a given agent at a remote site, the server notifies the agent's PC of the call. The PC can then control the agent's telephone to place a callback to the customer phone over the PSTN, or can prompt the agent to place the call manually. In another mode of operation, the customer's incoming audio call (either over the PSTN or VoIP) is routed to the agent's PC as VoIP data. The PC operates the agent's telephone as an audio input/output device for the VoIP call. Other operational modes are also possible.

There is therefore provided, in accordance with a preferred embodiment of the present invention, an adapter device, including:

a telephone port, for coupling to a line connector of a telephone;

a computer port, for coupling to a communication port of a computer terminal;

a line port, for coupling to a telephone line, which is linked to a telephone network; and

processing circuitry, coupled to the telephone port, computer port and line port, and arranged to operate in a plurality of operational modes, including at least:

a first operational mode, in which the circuitry couples the telephone via the line port to the telephone line so as to enable a telephone call to be conducted over the telephone network using the telephone, while the circuitry conveys data regarding the call to the terminal via the computer port, and

a second operational mode, in which the circuitry couples the telephone via the computer port to the computer terminal, so that the telephone operates as an audio input/output device of the terminal.

Preferably, the circuitry is further adapted to control one or more functions of the telephone responsive to commands from the computer terminal, wherein the one or more functions include at least one of the functions of placing the telephone call when the call is an outgoing call, and answering the telephone call when the call is an outgoing call. Additionally or alternatively, the one or more functions include operating at least one of a volume control, a mute control and a ring control of the telephone. Further additionally or alternatively, the one or more functions include at least one of transferring the call, forwarding the call and conferencing the call.

Preferably, the data conveyed by the processing circuitry to the terminal include an event indication conveyed to the terminal when an operator of the telephone picks up or hangs up the telephone. Additionally or alternatively, the data conveyed by the processing circuitry to the terminal include an indication upon occurrence of an event associated with the telephone selected from a group of events consisting of dialing, answering, flashing, establishment of a connection and termination of a connection.

In a preferred embodiment, the telephone call includes an incoming call, and the data conveyed by the processing circuitry to the terminal include a caller identification of a party placing the incoming call.

In a further preferred embodiment, in the second operational mode, the telephone serves as the audio input/output device for a packetized voice call placed by the terminal over a packet network. Preferably, in the second operational mode, the circuitry is operative to compress an audio input received from the telephone for transmission by the terminal.

There is also provided, in accordance with a preferred embodiment of the present invention, communication apparatus, including:

a computer terminal; and

telephone equipment, coupled to the computer terminal and to a telephone line, which is linked to a telephone network, so that the apparatus is operable in a plurality of operational modes, including at least:

a first operational mode, in which the telephone equipment is arranged to conduct a telephone call via the telephone line over the telephone network, while conveying data regarding the call to the terminal, and

a second operational mode, in which the telephone equipment is arranged to operate as an audio input/output device of the terminal.

Preferably, the terminal is linked to a packet network, and in the second operational mode, the terminal is arranged to conduct a packetized voice call over the packet network using the telephone equipment as the input/output device. Further preferably, the terminal is arranged to monitor the telephone call and the packetized voice call and to provide a status indication of the calls to a telephony application program associated with the terminal, wherein the status indication is substantially uniform for both the telephone and packetized voice calls. Most preferably, the terminal is arranged, responsive to the status indication, to present a user interface to a user of the telephone equipment, indicative of actions performed using the telephone equipment.

Additionally or alternatively, the terminal is linked, via the packet network, to exchange information regarding the telephone call and packetized voice call with a call center. Typically, the apparatus is deployed at a location remote from the call center, and is linked to the call center by the packet network. Preferably, the information includes textual information stored by the call center relating to parties with whom an operator of the apparatus speaks during the telephone and packetized voice calls. Additionally or alternatively, the information includes instructions conveyed from a routing server in the call center to the apparatus regarding handling of at least one of the telephone and packetized voice calls that was received initially at the call center.

There is additionally provided, in accordance with a preferred embodiment of the present invention, call center apparatus, for handling a voice call received from a customer at a call center site, the apparatus including:

a routing server, which is arranged to receive information regarding the voice call and to select an agent to handle the voice call responsive to the information; and

agent equipment, for operation by the agent selected to handle the call at a location remote from the call center site, the equipment being coupled to communicate with the routing server over a packet network, and further coupled to communicate through a public telephone network over a telephone line that does not pass through the call center, so as to handle the call in one of a plurality of operational modes, including at least a first operational mode in which the agent equipment communicates with the customer via the telephone line over the telephone network, and a second operational mode in which the agent equipment communicates with the customer via a packetized voice link over the packet network.

Preferably, the routing server is arranged to determine a skill set required for handling the voice call, and to select the agent responsive to the skill set.

Further preferably, the agent equipment is arranged to report to the routing server on a state of the call irrespective of whether the equipment is handling the call in the first or second operational mode.

There is further provided, in accordance with a preferred embodiment of the present invention, a method for communication, including:

coupling a telephone to a telephone line, linked to a telephone network, and to a communication port of a computer terminal;

operating the telephone in a first operational mode, in which the telephone is used to conduct a telephone call over the telephone network using the telephone, while conveying data regarding the call to the terminal via the communication port; and

operating the telephone in a second operational mode, in which the telephone functions as an audio input/output device of the terminal.

There is moreover provided, in accordance with a preferred embodiment of the present invention, a method for handling a voice call received at a call center site from a customer, the method including:

receiving information regarding the voice call at a routing server at the call center site;

selecting an agent to handle the voice call responsive to the information;

sending a message over a packet network from the routing server to agent equipment operated by the agent selected to handle the call at a location remote from the call center site;

responsive to the message, making a voice connection between the agent equipment and the customer though a public telephone network over a telephone line that does not pass through the call center; and

exchanging information relating to the customer between the agent equipment and the call center over the packet network while the voice connection is in progress.

The present invention will be more fully understood from the following detailed description of the preferred embodiments thereof, taken together with the drawings in which:

### BRIEF DESCRIPTION OF THE DRAWINGS

FIG. 1 is a schematic, pictorial illustration of a call center, as is known in the art;

FIG. 2 is a schematic, pictorial illustration of a virtual call center, in accordance with a preferred embodiment of the present invention;

FIG. 3 is a schematic, pictorial illustration showing equipment used by an agent associated with a virtual call center, in accordance with a preferred embodiment of the present invention; and

FIG. 4 is a block diagram that schematically illustrates functional elements of the equipment of FIG. 3, in accordance with a preferred embodiment of the present invention.

### DETAILED DESCRIPTION OF PREFERRED EMBODIMENTS

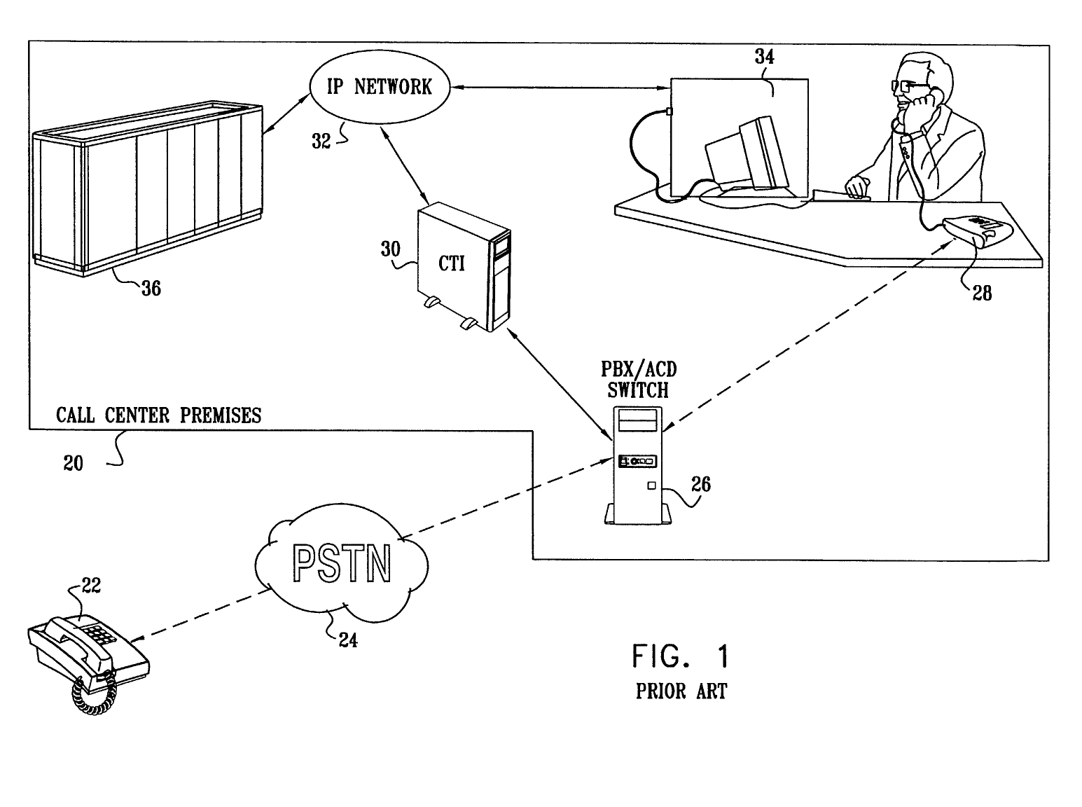

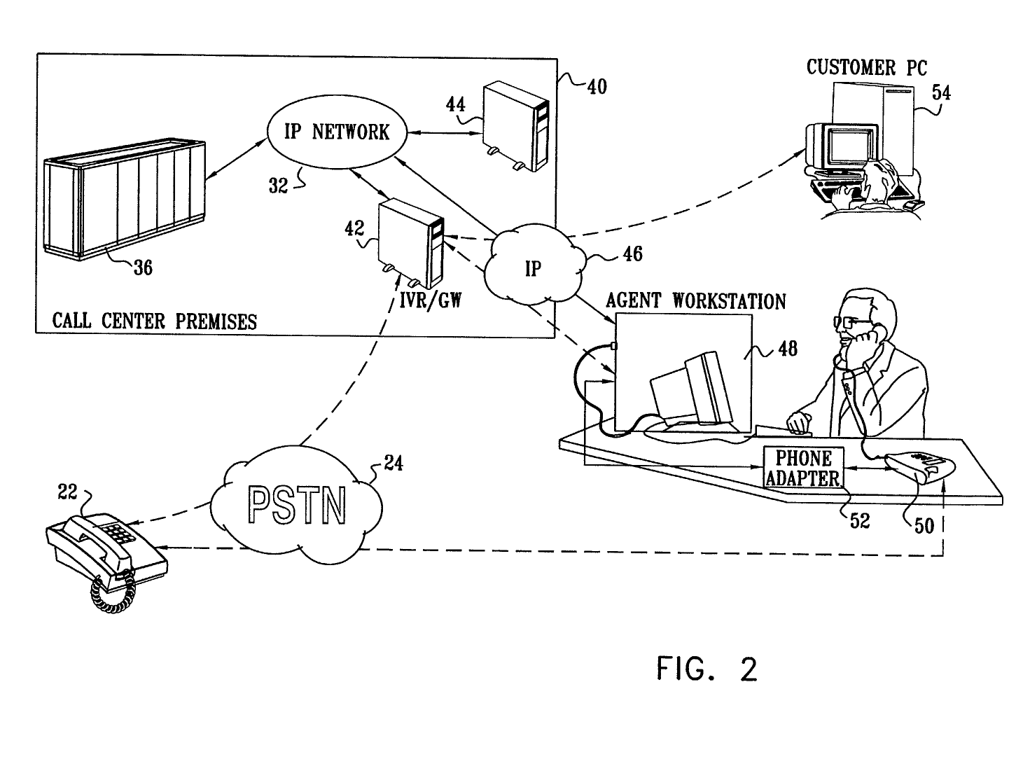

FIG. 2 is a schematic, pictorial illustration of a switchless virtual call center 40, in accordance with a preferred embodiment of the present invention. The figure illustrates the interaction of the call center with a customer phone 22, a customer PC 54, and agent equipment 56. Voice communication links (whether analog or VoIP) are indicated by dashed arrows, while other sorts of data communications are indicated by solid arrows. As can be seen in the figure, customer phone 22 connects to call center 40 and, in some operating modes, to an agent telephone 50 via PSTN 24. Customer PC 54 likewise accesses the call center through a packet network 46, such as the Internet. The agent is assumed to be working at a location remote from call center 40. Therefore, a workstation 48 used by the agent is connected to the call center through network 46 or through a different packet network. Alternatively, the agent may be located on the call center premises, in which case workstation 48 is typically connected to LAN 32, as shown in FIG. 1.

Several different modes of customer/agent communications are enabled by call center 40, for example:

Plain Old Telephone Service (POTS) between customer phone 22 and agent telephone 50 via PSTN 24. When the customer calls the call center on phone 22, the call is initially received and handled by an IVR/gateway server 42. By means of the IVR function, server 42 determines a VDN for the customer and passes this information, along with the caller ID of phone 22 and other relevant data, via LAN 32 to a routing server 44. Server 42 typically instructs the customer to hang up the phone and await a callback.

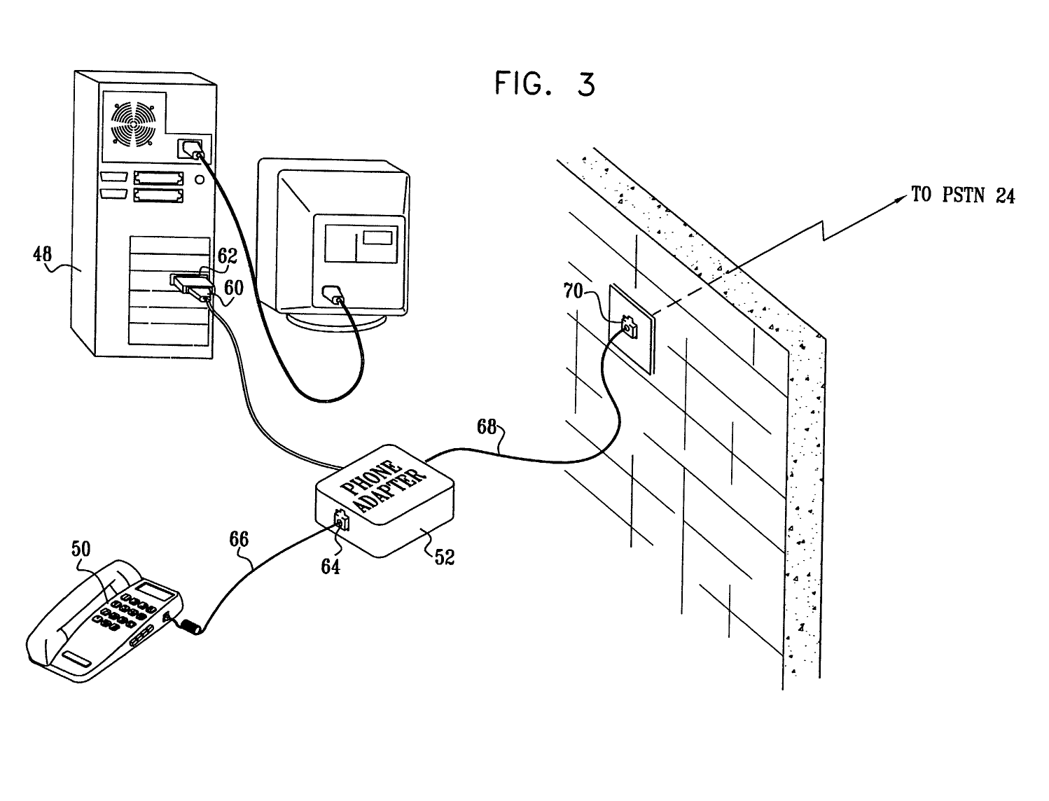

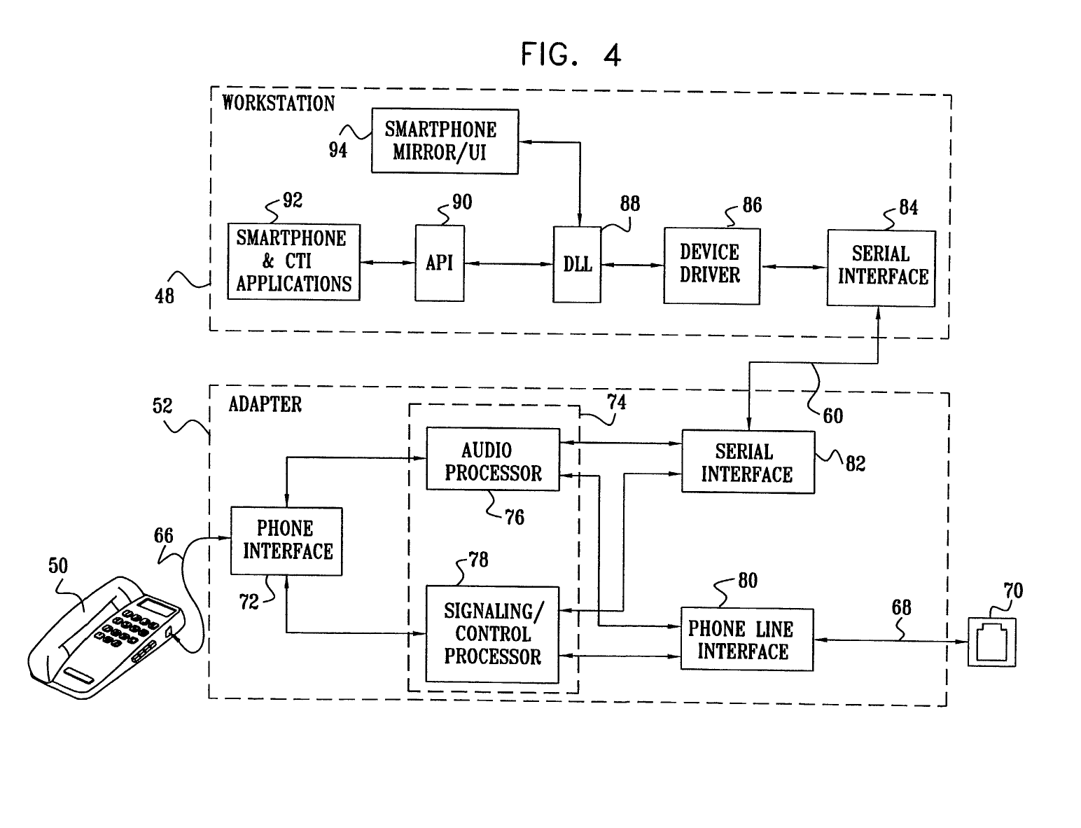

Routing server 44 determines that a certain agent, who is associated with equipment 56, is to handle the call. Server 44 accordingly signals the agent's workstation 48 via network 46. Workstation 48 controls telephone 50 via a phone adapter 52 to place a callback to customer phone 22 through PSTN 24. Adapter 52 is described in detail hereinbelow with reference to FIGS. 3 and 4. While placing the callback, the workstation retrieves and displays information needed by the agent to handle the call, which is typically drawn from back office servers 36.

Thus, from the agent's point of view, the workflow of communicating with the customer is substantially identical to that inside conventional call center 20 (FIG. 1), regardless of whether the agent is on site at call center 40 or in a remote location. This decentralized operation of the call center is made possible by the fact that agent workstation 48, with the help of adapter 52, has taken over CTI functions that are ordinarily performed in conventional call centers by a centralized server.

Alternatively, there may also be situations in which a repeat customer places a call directly from customer phone 22 to agent phone 50. In this case, adapter 52 detects the incoming call and passes the caller ID to workstation 48. The workstation uses the caller ID to retrieve appropriate records regarding this customer from call center 40 via network 46 and to display interface information for the agent. The agent may also use workstation 48 to place agent-initiated calls to customer phone 22.

POTS between customer phone 22 and call center 40, linked to VoIP between the call center and agent equipment 56. In this case, server 42 also acts as a VoIP gateway. When routing server 44 determines that the customer's call is to be handled by the agent using equipment 56, it instructs server 42 to create the audio connection between the customer and the agent by setting up a VoIP link over network 46 to agent workstation 48. To complete the connection, the workstation rings telephone 50 via adapter 52 and, when the agent picks up, generates an audio data stream through the adapter to the handset or headset of the telephone. Audio transmission from the agent back to the customer proceeds in mirror-image fashion, through adapter 52 to workstation 48, from there as VoIP through network 46, and then via server/gateway 42 as POTS audio back to customer phone 22. At the same time, workstation 48 performs the CTI and agent interface functions described above.

Preferably, the agent can also use the keypad on telephone 50 to place outgoing VoIP calls to customer phone 22 through workstation 48 and server 42. Telephone 50 thus alleviates completely the need to use an audio card, speakers and microphone in the workstation.

VoIP between customer PC 54 and call center 40 and between the call center and agent equipment 56. Handling of the customer call in this mode is similar to the previous one, in that the telephone connection between the agent and the customer passes through server 42. In this case, however, there is no need for server 42 to act as a VoIP gateway, since the entire link between the customer and the agent is packetized. This configuration may also be used to connect the customer and the agent by other, textual means of packetized communication, such as e-mail and Internet chat.

In order to support these different modes of customer/agent interaction, workstation 48 should be aware of every action and state change occurring on telephone 50. The workstation collects this information using adapter 52 along with appropriate telephony application program interface (TAPI) and driver software. Furthermore, the CTI functions of workstation 48, as well as the user interface encountered by the agent operating workstation 48 and telephone 50, should be consistent regardless of the operational mode of the equipment. To satisfy these objectives, the elements of equipment 56 preferably meet the following requirements:

Software on workstation 48 is notified whenever telephone 50 is picked up or hung up.

The software is also notified of every other significant action performed using telephone 50, such as dialing, answering, flash, connection establishment and call termination.

The software is able to dial outgoing calls, whether directly from workstation 48 or by controlling the dialer function in telephone 50. Preferably, the software includes voice generation capabilities, enabling it to leave voicemail messages automatically if the customer does not pick up.

The software is able to answer incoming calls, whether directly in workstation 48 or using telephone 50 as the answering device.

The software is notified when a headset is plugged into the telephone or unplugged from the telephone.

The software is able to invoke supplemental telephone services, such as call transfer, call forward and conferencing of calls placed or received using telephone 50.

Telephone user interface functions, such as volume control, mute and ring control, are controllable from both telephone 50 and by the software.

User interface software on workstation 48 provides pop-up application windows for the agent on the workstation screen in response to telephony events, whether the events originate with the telephone or on the workstation itself.

When workstation 48 is used for VoIP calls, as described above, delay of the audio signals should be minimized. Standard audio drivers used for PC sound cards on Windows™ platforms introduce inherent delays, and custom software is therefore preferably used for the audio link between workstation 48 and telephone 50.

In addition, routing server 44 maintains a directory of the skills and current states of all of the agents who are accessible to call center 40, whether these agents are located in the call center or at remote locations. Workstations 48 communicate with the routing server at start-up and from time to time thereafter in order to provide the directory information. The directory is used by server 44 to perform call distribution according to the skills, loads and availability of the agents.

The functions of call center 40 and of agent equipment 56 that are described herein are preferably implemented by means of suitable software running on servers 42 and 44 and on workstation 48. This software is typically downloaded to the servers and workstations in electronic form, over networks 32 and 46, for example. Alternatively or additionally, the software may be provided on tangible media, such as CD-ROM or DVD, for installation on the servers and workstations.

Reference is now made to FIGS. 3 and 4, which schematically show details of agent equipment 56, in accordance with a preferred embodiment of the present invention. FIG. 3 is a schematic pictorial illustration of the equipment, while FIG. 4 is a block diagram showing functional elements of workstation 48 and adapter 52.

Adapter 52 interconnects workstation 48, telephone 50 and a telephone line to PSTN 24, represented in the figures by a telephone line plug 70. To make these connections, adapter 52 preferably includes the following ports or connection devices:

A serial data connector 60, which attaches to a serial port 62 of workstation 48. Alternatively, a parallel port, wireless or optical connection may be used.

A telephone connector 64, typically a standard RJ-11 receptacle, which receives a line connector 66 of telephone 50. Normally, the telephone line connector would be plugged into line plug 70.

A telephone line connector 68, which plugs into line plug 70 instead of line connector 66 of telephone 50.

Referring now to FIG. 4, a phone interface 72 in adapter 52 is coupled to line connector 66 of telephone 50, so as to convey signals between the telephone and a digital signal processor (DSP) 74. Typically, the telephone output and input have the form of analog audio signals, and therefore either interface 72 or DSP 74 comprises analog/digital and digital/analog converters. The DSP has two primary functions:

An audio processor 76 performs voice processing such as echo canceling; detection and generation of Dual Tone Multi-Frequency (DTMF) signals, normally generated by the telephone keypad; voice activity detection; and voice compression/decompression when telephone 50 is used as the audio input/output device in VoIP configurations.

A signaling and control processor 78 intercepts signals from the telephone and generates events to be processed by workstation 48.

Alternatively, these functions may be divided up among two or more separate processors in adapter 52. A serial interface 82 comprises hardware and software drivers needed to couple adapter 52 to a matching serial interface 84 of workstation 48. A phone line interface 80 comprises circuitry for coupling adapter 52 to the telephone line through plug 70. A bypass line (not shown) may be provided between phone interface 72 and line interface 80.

Software running on workstation 48 includes a device driver 86, which sends instructions and data to adapter 52 and receives event messages from the adapter via serial interface 84. A dynamic load library (DLL) 88 communicates with driver 86. The DLL provides a set of application program interfaces (APIs) 90 for communicating with applications running on the workstation. Optionally, two separate DLLs are provided for the two different types of telephony supported by equipment 56: telephone calls over PSTN 24 and VoIP calls over network 46.

APIs 90 provide a common interface to applications 92 running on workstation 48. The interface is protocol-independent, i.e., it remains consistent regardless of whether equipment 56 is being used for PSTN calls or VoIP calls, and regardless of the specific VoIP application protocol that is in use. Applications 92 typically include both CTI applications, for coordinating between workstation 48 and call center 40, and “Smartphone” applications, for controlling the operation of telephone 50 and of other elements of equipment 56. Preferably, the Smartphone applications include control and monitoring of the following functions and system states:

Agent login/logoff

Agent ready/not ready

Telephone off-hook/on-hook

Telephone call status

Power dialing

Predictive dialing

Directory dialing

Volume control

Transfer

Mute

Detect/generate DTMF

Call waiting

Caller ID processing

Call screening

Call logging

Conference with speaker identification

Consultation during a call.

Other application functions will be apparent to those skilled in the art.

In addition, workstation 48 supports a user interface 94, which mirrors events involving telephone 50 and enables an agent to follow these events in an intuitive visual manner. These functions are particularly important when equipment 56 is handling multiple calls simultaneously (as is often the case in call centers) or when the agent must coordinate activities with another agent workstation at a different location. Interface 94 listens for events arriving from adapter 52 at DLL 88, and maps the events to the user interface on the workstation display screen. Commands that are sent from the workstation to the adapter are similarly mirrored by the user interface. Preferably, each such event or command is represented by an appropriate graphical image or other cue on the display.

Although preferred embodiments are described herein with reference to certain specific arrangements of equipment 56 and call center 40, it will be apparent to those skilled in the art that alternative hardware and software configurations may also be used to implement the principles of the present invention. For example, the functions of telephone 50 and adapter 52 may be combined into a single telephone unit. Similarly, other functional elements of the preferred embodiments may be united or separated out. It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An adapter device, comprising:
a telephone port, for coupling to a line connector of a telephone;
a computer port, for coupling to a communication port of a computer terminal;
a line port, for coupling to a telephone line, which is linked to a telephone network; and
processing circuitry, coupled to the telephone port, computer port and line port, and arranged to operate in a plurality of operational modes, including at least:
a first operational mode, in which the circuitry couples the telephone via the line port to the telephone line so as to enable a telephone call to be conducted over the telephone network using the telephone, while the circuitry conveys data regarding the call to the terminal via the computer port, and
a second operational mode, in which the circuitry couples the telephone via the computer port to the computer terminal, so that the telephone operates as an audio input/output device of the terminal.

2. A device according to claim 1, wherein the circuitry is further adapted to control one or more functions of the telephone responsive to commands from the computer terminal.

3. A device according to claim 2, wherein the one or more functions comprise at least one of the functions of placing the telephone call when the call is an outgoing call, and answering the telephone call when the call is an outgoing call.

4. A device according to claim 2, wherein the one or more functions comprise operating at least one of a volume control, a mute control and a ring control of the telephone.

5. A device according to claim 2, wherein the one or more functions comprise at least one of transferring the call, forwarding the call and conferencing the call.

6. A device according to claim 1, wherein the data conveyed by the processing circuitry to the terminal comprise an event indication conveyed to the terminal when an operator of the telephone picks up or hangs up the telephone.

7. A device according to claim 1, wherein the data conveyed by the processing circuitry to the terminal comprise an indication upon occurrence of an event associated with the telephone selected from a group of events consisting of dialing, answering, flashing, establishment of a connection and termination of a connection.

8. A device according to claim 1, wherein the telephone call comprises an incoming call, and wherein the data conveyed by the processing circuitry to the terminal comprise a caller identification of a party placing the incoming call.

9. A device according to claim 1, wherein in the second operational mode, the telephone serves as the audio input/output device for a packetized voice call placed by the terminal over a packet network.

10. A device according to claim 9, wherein in the second operational mode, the circuitry is operative to compress an audio input received from the telephone for transmission by the terminal.

11. Communication apparatus, comprising:
a computer terminal; and
telephone equipment, coupled to the computer terminal and to a telephone line, which is linked to a telephone network, so that the apparatus is operable in a plurality of operational modes, including at least:
a first operational mode, in which the telephone equipment is arranged to conduct a telephone call via the telephone line over the telephone network, while conveying data regarding the call to the terminal, and
a second operational mode, in which the telephone equipment is arranged to operate as an audio input/output device of the terminal.

12. Apparatus according to claim 11, wherein the terminal is arranged to control one or more functions of the telephone equipment associated with conducting the telephone call.

13. Apparatus according to claim 11, wherein the data conveyed to the terminal comprise an indication upon occurrence of an event associated with operation of the telephone equipment.

14. Apparatus according to claim 11, wherein the terminal is linked to a packet network, and wherein in the second operational mode, the terminal is arranged to conduct a packetized voice call over the packet network using the telephone equipment as the input/output device.

15. Apparatus according to claim 14, wherein the terminal is arranged to monitor the telephone call and the packetized voice call and to provide a status indication of the calls to a telephony application program associated with the terminal.

16. Apparatus according to claim 15, wherein the status indication is substantially uniform for both the telephone and packetized voice calls.

17. Apparatus according to claim 16, wherein the terminal is arranged, responsive to the status indication, to present a user interface to a user of the telephone equipment, indicative of actions performed using the telephone equipment.

18. Apparatus according to claim 14, wherein the terminal is linked, via the packet network, to exchange information regarding the telephone call and packetized voice call with a call center.

19. Apparatus according to claim 18, wherein the apparatus is deployed at a location remote from the call center, and is linked to the call center by the packet network.

20. Apparatus according to claim 18, wherein the information comprises textual information stored by the call center relating to parties with whom an operator of the apparatus speaks during the telephone and packetized voice calls.

21. Apparatus according to claim 18, wherein the information comprises instructions conveyed from a routing server in the call center to the apparatus regarding handling of at least one of the telephone and packetized voice calls that was received initially at the call center.

22. Call center apparatus, for handling a voice call received from a customer at a call center site, the apparatus comprising:
a routing server, which is arranged to receive information regarding the voice call and to select an agent to handle the voice call responsive to the information; and
agent equipment, for operation by the agent selected to handle the call at a location remote from the call center site, the equipment being coupled to communicate with the routing server over a packet network, and further coupled to communicate through a public telephone network over a telephone line that does not pass through the call center, so as to handle the call in one of a plurality of operational modes, including at least a first operational mode in which the agent equipment communicates with the customer via the telephone line over the telephone network, and a second operational mode in which the agent equipment communicates with the customer via a packetized voice link over the packet network.

23. Apparatus according to claim 22, wherein the agent equipment is further arranged to exchange textual information relating to the customer with the call center site over the packet network in connection with the voice call.

24. Apparatus according to claim 22, wherein the routing server is arranged to determine a skill set required for handling the voice call, and to select the agent responsive to the skill set.

25. Apparatus according to claim 22, wherein the agent equipment is arranged to report to the routing server on a state of the call irrespective of whether the equipment is handling the call in the first or second operational mode.

26. A method for communication, comprising:
coupling a telephone to a telephone line, linked to a telephone network, and to a communication port of a computer terminal;
operating the telephone in a first operational mode, in which the telephone is used to conduct a telephone call over the telephone network using the telephone, while conveying data regarding the call to the terminal via the communication port; and
operating the telephone in a second operational mode, in which the telephone functions as an audio input/output device of the terminal.

27. A method according to claim 26, and comprising conveying a command from the computer terminal through the communication port so as to control one or more functions associated with the telephone.

28. A method according to claim 27, wherein the one or more functions comprise at least one of the functions of placing the telephone call when the call is an outgoing call, and answering the telephone call when the call is an outgoing call.

29. A method according to claim 27, wherein the one or more functions comprise operating at least one of a volume control, a mute control and a ring control of the telephone.

30. A method according to claim 27, wherein the one or more functions comprise at least one of transferring the call, forwarding the call and conferencing the call.

31. A method according to claim 26, wherein conveying the data comprises conveying an event indication to the terminal when an operator of the telephone picks up or hangs up the telephone.

32. A method according to claim 26, wherein conveying the data comprises conveying an indication upon occurrence of an event associated with the telephone selected from a group of events consisting of dialing, answering, flashing, establishment of a connection and termination of a connection.

33. A method according to claim 26, wherein the telephone call comprises an incoming call, and wherein conveying the data comprises conveying a caller identification of a party placing the incoming call.

34. A method according to claim 26, wherein operating the telephone in the second operational mode comprises using the telephone as the audio input/output device for a packetized voice call placed by the terminal over a packet network.

35. A method according to claim 34, wherein using the telephone comprises compressing an audio input received from the telephone for transmission by the terminal.

36. A method according to claim 34, wherein operating the telephone in the first and second operational modes comprises monitoring the telephone call and the packetized voice call, respectively, and providing a status indication of the calls to a telephony application program associated with the terminal.

37. A method according to claim 36, wherein the status indication is substantially uniform for both the telephone and packetized voice calls.

38. A method according to claim 36, and comprising presenting, responsive to the status indication, a user interface to a user of the telephone equipment, indicative of actions performed using the telephone equipment.

39. A method according to claim 34, and comprising exchanging information regarding the telephone call and packetized voice call with a call center.

40. A method according to claim 39, wherein the terminal and telephone are deployed at a location remote from the call center, and wherein exchanging the information with the call center comprises exchanging the information over the packet network.

41. A method according to claim 39, wherein exchanging the information comprises receiving textual information at the terminal from the call center relating to parties with whom an operator of the terminal speaks during the telephone and packetized voice calls.

42. A method according to claim 39, wherein exchanging the information comprises receiving instructions conveyed from a routing server in the call center to the terminal regarding handling of at least one of the telephone and packetized voice calls that was received initially at the call center.

43. A method for handling a voice call received at a call center site from a customer, the method comprising:
receiving information regarding the voice call at a routing server at the call center site;
selecting an agent to handle the voice call responsive to the information;
sending a message over a packet network from the routing server to agent equipment operated by the agent selected to handle the call at a location remote from the call center site;
responsive to the message, making a voice connection between the agent equipment and the customer though a public telephone network over a telephone line that does not pass through the call center; and
exchanging information relating to the customer between the agent equipment and the call center over the packet network while the voice connection is in progress.

44. A method according to claim 43, and comprising receiving a further voice call at the call center from a further customer, and responsive to the further voice call, sending a further message to the agent equipment, and establishing a packetized voice link between the agent equipment and the customer over the packet network.

45. A method according to claim 44, wherein exchanging the information comprises reporting from the agent equipment to the routing server on a state of the call irrespective of whether the equipment is communicating with the customer over the telephone line or over the packetized voice link.

46. A method according to claim 43, wherein selecting the agent comprises determining a skill set required for handling the voice call, and selecting the agent responsive to the skill set.

47. A method according to claim 43, wherein exchanging the information comprises receiving textual information regarding the customer at the agent equipment from the call center.
